(19) United States
(12) Patent Application Publication
(10) Pub. No.: US 2021/0107329 A1
(43) Pub. Date: Apr. 15, 2021

(54) Pneumatic Sway Assist

(71) Applicant: Mark Andrew Jensen, Bowdon, GA (US)

(72) Inventor: Mark Andrew Jensen, Bowdon, GA (US)

(21) Appl. No.: 16/601,301

(22) Filed: Oct. 14, 2019

(51) Int. Cl. B60G 17/018; B60G 17/015; B60G 17/016; B60G 17/019; B60G 15/06; B60G 17/052

(52) U.S. Cl. CPC B60G 17/018; B60G 2800/22; B60G 17/0164; B60G 17/01916; B60G 15/06; B60G 17/052; B60G 2202/112; B60G 2202/12; B60G 2202/152; B60G 2202/412; B60G 2204/82; B60G 2204/8304; B60G 2400/10; B60G 2401/20; B60G 2401/28; B60G 2400/98; B60G 2400/05; B60G 2800/18; B60G 17/0155

(57) ABSTRACT

A self-contained pneumatic anti-sway assist vehicle body roll control system to supplement existing vehicle suspension by means of sharing load support primary and secondary volumetric gas chamber pressures for soft ride over normal, level road surfaces; then by blocking said secondary gas chambers at load side of vehicle to summarily increase spring rate within its primary load support gas chamber for increased vehicle body suspension support during lateral forces encountered with right and left turns and/or with vehicle body lean when off-camber.

### CROSS-REFERENCE TO RELATED APPLICATIONS

N/A

### BACKGROUND OF THE INVENTION

For both highway and off-road driving, the ability of each of a vehicle's wheels to act independently and without negative transmitted influence from other wheels over obstacles and irregularities in the road surface has proven to substantially improve ride comfort. However, full and complete independence of each wheel results in loss of vehicle body roll stability. Automotive anti-sway bars provide vehicle body lateral sway control and stability via a mechanically linked semi-rigid steel bar connected horizontally across the frame of the vehicle whose ends connect, or are hinged, directly to the outer extremities of either the front or rear axle. As such, when lateral force causes the vehicle body to lean during a turn, or when body weight is shifted to one side when off-camber on a hill, either to the right or left, sprung load is transmitted via the anti-sway bar to the opposite unloaded side of the vehicle effectively combining left and right side suspension spring forces to the load side of the vehicle resulting in a leveling, stabilizing effect.

The disadvantages of semi-rigid steel anti-sway bars are (1) added weight of the anti-sway bar where excessive weight is a concern, (2) loss of vehicle straight-line tracking stability over rough, uneven terrain due to combined left and right side spring forces being directed to a single wheel in upward motion, which combined spring force is then transmitted vertically and horizontally to the vehicle body, thus creating a harsh lateral/side movement of the vehicle, and (3) loss of ride smoothness when one wheel contacts an irregularity in the road that results in that wheel's increased resistance to upward motion due to the above-stated combined spring forces of both right and left side wheels linked via the anti-sway bar producing a more pronounced shock to the vehicle body and its occupants from the road irregularity, where conversely, had each wheel been able to act independently of the other, said shock would have been significantly lessened.

Other than, or in addition to, use of an anti-sway bar, other body-leveling means employing electrics or hydraulics via computer or reactive controls can be slow, complex, or unreliable to react quickly enough to road surface and terrain irregularities, or these systems might require the addition of hydraulic or pneumatic pumps or venting to atmosphere of pneumatic pressures, then restoring said pressures via pump to maintain a vehicle leveling effect. Particularly in an off-road, high-speed environment, the operator is preoccupied with driving and vehicle guidance and cannot easily by himself operate a multiplicity of vehicle leveling controls or wait upon slow reactive controls to maintain vehicle attitude and stability.

### BRIEF SUMMARY OF THE INVENTION

The Pneumatic Sway Assist invention, herein referred to as PSA, simulates the intended beneficial stability aspects of an automotive anti-sway bar while negating the negative effects of same, resulting in added performance benefits for vehicles that rely on pneumatic or gas-charged suspension systems, particularly, off-road vehicles. Both slow and high-speed stability and ability to navigate rough, difficult terrain are essential to off-road vehicle safety and comfort.

The PSA is completely self-contained, reacts instantaneously to changes in road surface irregularities and body lean, and requires neither pressure vents to atmosphere nor pressure-restoring pump input. It functions in combination with, or in place of the anti-sway bar of a vehicle, particularly that of an off-road vehicle, and creates a pneumatic coupling between the vehicle's pneumatic suspension and the vehicle body that engages only during left or right turn forces or when vehicle off-camber tilt reaches that of a predetermined PSA activation angle. The level of stability achieved compared to that of an anti-sway bar is adjustable and dependent upon the physical dimensions of available compressible gas volumes in the vehicle's gas suspension system and that of the PSA unit. With the PSA installed, normal vehicle ride combines compressible gas volumes of the vehicle's gas shocks or struts with the volume of the PSA. The PSA automatically and mechanically blocks and temporarily isolates the available compressible gas volume of the PSA from the compressible gas volume of either the right or left side total volume, restricting compressible gas volume of the shock or strut to its internal cylinder only, effectively increasing spring rate on the load side of the vehicle during turns and/or when vehicle inclination exceeds that of a predetermined PSA activation angle. By pneumatically isolating a significant portion of the total net compressible volume at the load side of the vehicle, a right or left side wheel can react independently of the opposite side wheel to irregularities in the road surface without having the semi-rigid mechanical link between left and right side wheels via a steel semi-rigid anti-sway bar that is engaged full-time. Anti-sway bar-like stability is activated only when the PSA unit senses lateral forces from a turn or from inclination forces and deactivates both right and left side functions for normal level driving, increasing vehicle occupant safety and comfort.

### BRIEF DESCRIPTION OF THE DRAWINGS

The above features, aspects, and advantages of the subject matter are better understood and further illustrated in the accompanying drawings where:

FIG. 1 shows a cross-section view of the of complete system and components.

FIG. 2L shows components of left-side components of subject matter.

FIG. 2R shows components of right-side components of subject matter.

FIG. 3 shows relationship and view angles from an end view for FIG. 1 and FIG. 4 cross-section details.

FIG. 4 illustrates functions of components in FIG. 2L when subject matter invention is inclined at a predetermined activation angle.

FIG. 5 is an overview of subject matter principal components.

### DETAILED DESCRIPTION OF THE INVENTION

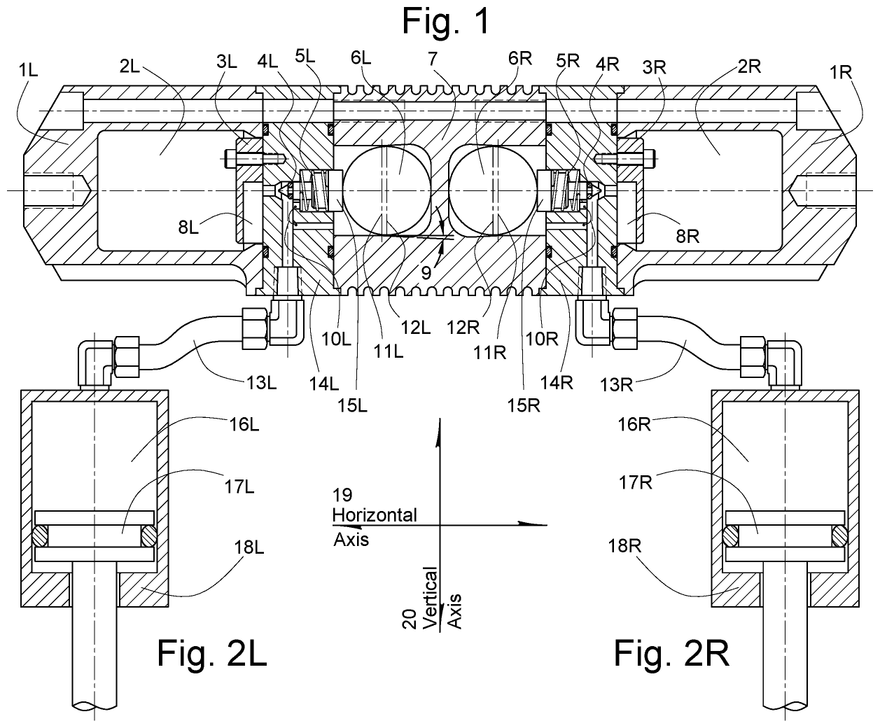

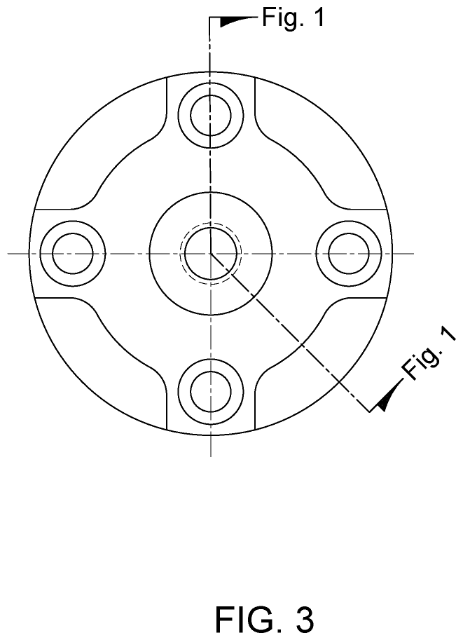

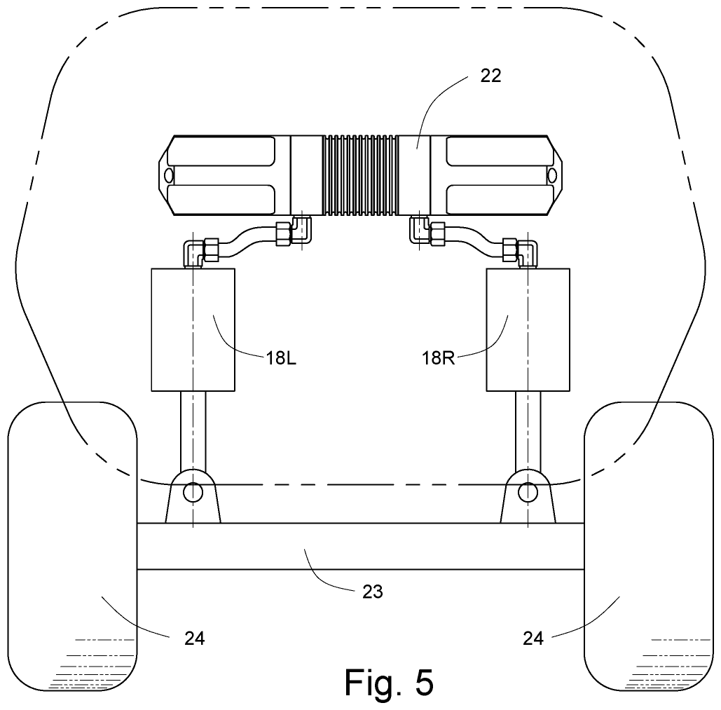

FIG. 1 depicts an overall cross-section view of the invention with patent claim title Pneumatic Sway Assist, referred to herein in abbreviated form, PSA or Invention, principal body of which is illustrated as FIG. 5 assembly 22. FIG. 1 with its several parts and subassemblies illustrates the PSA in its normal, level ride configuration with respect to a vehicle body suspended upon FIG. 5 wheels 24, tracks, or other vehicle-to-road direct contact means, by means of gas struts, or by leaf or coil springs, specifically with said springs functioning in combination with air or gas load supporting members used either as a damping means or as additional suspension support of said vehicle body.

FIG. 2L and FIG. 2R with referenced separate item numbers, also shown with suffix letters L and R, represent left-side and right-side air or gas shocks or struts respectively. In said normal, level ride configuration, the subject vehicle is presumed to be traversing a highway or off-road surface in a straight-line tract with minimal disruption from road surface irregularities and external forces that might require body roll control assistance by mechanical, hydraulic, pneumatic, or electrical means.

In FIG. 1 and FIG. 5, the PSA unit is affixed to the vehicle body in a horizontal and level position to directly and mechanically react with vehicle body inclination. Representative gas load support moving end members in FIG. 2L and FIG. 2R are affixed or hinged at one end to the vehicle's axle 23 or control arm member and the other end affixed or hinged to the vehicle body, left and right sides respectively.

Left and right-side PSA pneumatic circuits operate independently of each other, separated by a wall in balance block 7 and seal rings that prevent pressurized gasses from migrating between and among cylinders 1L & 1R, pilot manifolds 14L & 14R, and balance block 7. Left and right sides of the PSA are acted upon by outside lateral forces during vehicle left or right directional turns and/or changes in vehicle body inclination about the vehicle's center line longitudinal axis caused either by said lateral forces or by an off-camber environment where the vehicle leans to one side or the other while traversing along the side of a hill or embankment.

The combined compressible gas volume 2L of left side PSA unit cylinder 1L and gas volume 16L of load support or load support assist cylinder 18L, a separate and independent pneumatic circuit from combined gas volume 2R of right side PSA unit cylinder 1R and gas volume 16R of load support cylinder 18R, provide cushioning from road surface irregularities and ride comfort for occupants of said vehicle body suspended upon aforementioned suspension support. In said configuration, left side cylinder gas volumes 2L and 16L are shared via passageway 13L and open pilot valve 15L. Spring 5L, with sufficient force to maintain pilot valve 15L in the open position, contained within pilot manifold 14L, also maintains gravity, lateral force, and inclination-influenced ball 6L in a retracted position within its cavity of balance cylinder 7.

Further assurance to maintain ball 6L in a retracted position when road surface irregularities produce suspension component and vehicle body oscillations coincident with vertical axis 20 is provided by predetermined fixed angle 9 sufficient to bias ball 6L, which resides on the inclined plane of angle 9, to roll forcibly to its right against the cavity wall in balance cylinder 7 and away from pilot valve 15L. Ball 6L center line 12L is offset by a sufficient distance to the right of center line 11L to retain ball 6L on its inclined plane during normal, level riding, which represents the start pivot point of angle 9 relative to horizontal axis 19.

Pressure spikes produced coincident with vertical axis 20 upward motion of piston 17L, directly linked to same vertical axis 20 motion of left-side vehicle wheel 24, are prevented from inadvertently influencing preferred stationary position of pilot valve 15L by directing equalized pressure spike influences via twin equally-sized passageways 10L to both sides of pilot valve 15L.

Transient collected oil that might accumulate within balance cylinder 1L in a mixed gas/oil emulsion environment is returned via passageway 8L in oil return plate 3L to chamber 16L within load support cylinder 18L during the downward stroke of piston 17L which creates a negative pressure potential in chamber 16L relative to that pressure within balance cylinder 1L.

Right side component items and features 1R, 2R, 3R, 4R, 5R, 6R, 8R, 10R, 11R, 12R, 13R, 14R, 15R, 16R, 17R, and 18R react and operate in the same manner to vehicle right-side influences and forces as those component items and features described in the preceding paragraph related to vehicle left-side influences and forces depicted with letter L-suffix item numbers.

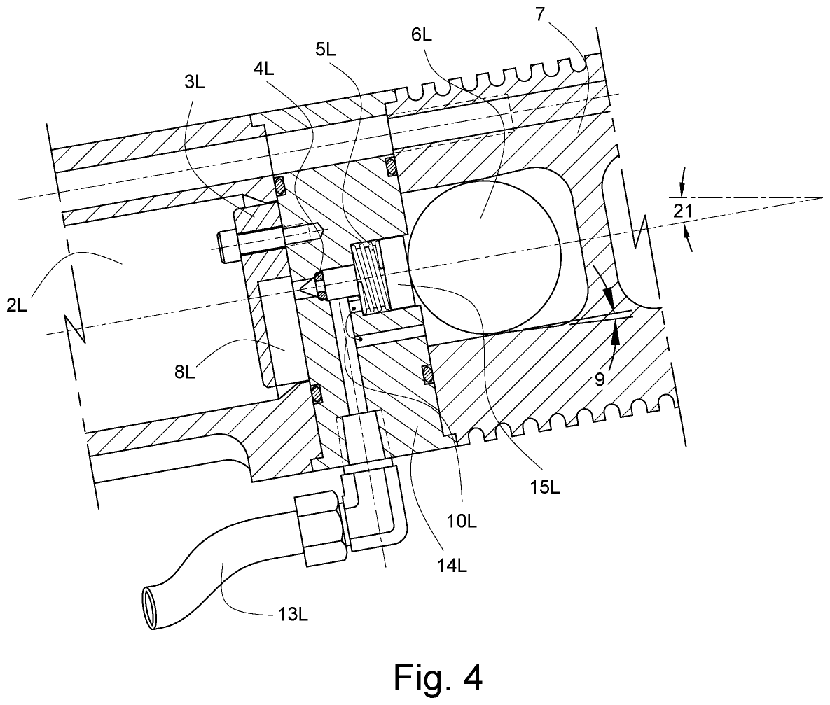

FIG. 4 illustrates the reaction of the PSA to vehicle body angle 21 inclination relative to deviation from horizontal axis 19. In said inclined orientation, angle 21 represents the desired and maximum allowed angular deviation from the horizontal plane before action is required from the PSA to activate added suspension support to suspension load support in FIG. 2L on the load side of the vehicle during a right directional turn or off-camber vehicle lean to the left.

To avoid redundancy of explanation, FIG. 4, representing left-side components, will be used to represent both left-side and right-side component functions. FIG. 2R-related functions will herein be considered equal in operation, yet opposite in reaction depending upon whether the vehicle is subjected to left-side forces or right-side forces.

At said angle 21 inclination, ball 6L will dislodge from the wall separating left and right-side PSA pneumatic circuits in balance block 7, overcome lesser fixed angle 9 relative to greater angle 21, and roll to the left contacting pilot valve 15L. Weight of gravity-influenced ball 6L at angle 21 is sufficient to overcome spring force of spring 5L and close pilot valve 15L, blocking passageway 13L.

With passageway 13L blocked, balance cylinder 1L compressible gas volume 2L is blocked and isolated from gas volume 16L in cylinder 18L resulting in an increased spring rate at load side of vehicle. Further compression in the vertical direction of piston 17L is inhibited by said increased spring rate, providing the added load support needed on the load side of the vehicle.

Further downward and upward pumping action of piston 17L due to wheel motion over road surface irregularities while at angle 21 vehicle orientation will further increase pressure trapped in compressible volume 16L and subsequently result in greater spring rate on the vehicle load side. During such downward motion of piston 17L, if pressure 2L in cylinder 1L is greater than pressure 16L in cylinder 18L, pressure 2L will overcome weight of pilot valve 5L and ball 6L forcing them to a momentary open position, allowing any trapped positive differential pressure in 2L relative to lower pressure in 16L to migrate to the lesser pressure potential at 16L until said cylinder pressures are equalized, whereupon the combined weights of pilot valve 15L and ball 6L will again close pilot valve 15L. Any subsequent upward motion of piston 17L creates a positive pressure that will maintain pilot valve 15L closed.

Once vehicle returns to normal level orientation with angle 21 at zero, the spring force of spring 5L will return pilot valve 15L to its open position, again sharing compressible gas volumes 2L and 16L for a softer level-ride spring rate. Ball 6L will once again rest in its default position against the back wall of its cavity in balance block 7 on the angular plane referenced by fixed angle 9 which aids to maintain ball position in the level orientation.

1. A self-contained pneumatic anti-sway assist vehicle body roll control to produce a leveling effect of a vehicle body that comprises:
no pressure vent to atmosphere nor external pump input,
a movable valve to open or close a pneumatic passageway,
wherein said movable valve blocks and isolates a vehicle body load support gas chamber from potentially shared volume of a secondary gas chamber, that when said secondary gas chamber is isolated, primary load-side gas chamber spring rate is increased, thus providing additional load support at load side of vehicle,
wherein said movable valve requires no operator input, and activates reactively and automatically,
wherein said movable valve is activated by vehicle body inclination/deviation from a horizontal/level plane and/or lateral forces induced upon vehicle body during turns.

2. Body roll control of claim 1 wherein vehicle load support primary or secondary means is via air or gas shock or strut.

3. Body roll control of claim 1 wherein primary vehicle load support is by means of coil or leaf spring with supplementary support provided by air or gas shock or strut.

4. Body roll control of claim 1 wherein a gravity and/or lateral force-influenced weighted ball mechanically senses vehicle body lean and acts directly upon said movable valve to open and close said pneumatic passageway.

5. Body roll control of claim 1 wherein a gravity and/or lateral force-influenced weighted ball mechanically senses vehicle body lean and activates an electrical circuit in series with a common art electrical solenoid to open and close said pneumatic passageway.

6. Body roll control of claim 1 wherein a common art mercury switch senses vehicle body lean and activates an electrical circuit in series with a common art solenoid to open and close said pneumatic passage.

7. Body roll control of claim 1 wherein a common art gyroscopic attitude device senses vehicle body lean and activates an electrical circuit in series with a common art solenoid to open and close said pneumatic passageway.

8. Body roll control of claim 1 wherein invention is rigidly mounted in-line with vehicle longitudinal axis to control or minimize front-to-rear suspension sag or “squat” during acceleration and deceleration.
